(19) United States
(12) Patent Application Publication
(10) Pub. No.: US 2026/0087024 A1
(43) Pub. Date: Mar. 26, 2026

(54) DETECTING USER AGITATION APPLICATION INTERACTION

(71) Applicant: DoorDash, Inc., San Francisco, CA (US)

(72) Inventors: Harsh Alkutkar, Los Angeles, CA (US); Colin Salter, Mill Valley, CA (US)

(73) Assignee: DoorDash, Inc., San Francisco, CA (US)

(21) Appl. No.: 19/331,306

(22) Filed: Sep. 17, 2025

Related U.S. Application Data
(60) Provisional application No. 63/698,160, filed on Sep. 24, 2024.

(51) Int. Cl. G06F 16/2457

(52) U.S. Cl. CPC G06F 16/24578

(57) ABSTRACT

A method includes retrieving, by the user device from a database on the user device, historical data, and real-time client device data. The method includes determining an agitation score based on the real-time client device data and the historical data, and then performing an action based on the agitation score.

### CROSS REFERENCE TO RELATED APPLICATIONS

This application is a non-provisional application of U.S. Provisional Application No. 63/698,160, filed on Sep. 24, 2024, which is herein incorporated by reference in its entirety for all purposes.

### BRIEF SUMMARY

Embodiments of the invention introduce a method that integrates multiple behavioral and contextual signals directly on a user device, enabling an application on the user device to respond to user agitation. In some cases, the user agitation can be as a result of the user's frustration with a current situation or the user's hunger. Embodiments of the invention can predict a user agitation by analyzing a combination of client-side and server-side parameters in real-time. If the user is agitated, the user device can perform an action in response to the agitation. For example, a set of images may be presented to the user when the user is in an agitated state. The set of images may be different than images that might be shown to the user when the user is in a non-agitated state.

One embodiment of the invention includes a method comprising: retrieving, by the user device from a database on the user device, historical data and real-time client device data; determining, by the user device, an agitation score based on the real-time client device data and the historical data; and performing, by the user device, an action based on the agitation score.

Another embodiment of the invention includes a user device comprising: a processor; and a non-transitory computer readable medium storing a plurality of instructions that, when executed, cause the processors to perform a method comprising: retrieving, by the user device from a database on the user device, historical data and real-time client device data; determining, by the user device, an agitation score based on the real-time client device data and the historical data; and performing, by the user device, an action based on the agitation score.

Another embodiment of the invention includes a system comprising: a user device comprising a processor, and a non-transitory computer readable medium storing a plurality of instructions that, when executed, cause the processors to perform a method comprising retrieving, by the user device from a database on the user device, historical data, and real-time client device data, determining, by the user device, an agitation score based on the real-time client device data and the historical data, and performing, by the user device, an action based on the agitation score; and a central server computer storing the historical data in communication with the user device.

These and other embodiments are described in further detail below.

### BRIEF DESCRIPTION OF THE DRAWINGS

FIG. 1 shows a system according to an embodiment.

FIG. 2 shows a block diagram of a central server computer according to an embodiment.

FIG. 3 shows a block diagram of a user device according to an embodiment.

FIGS. 4 and 5 shows flow diagrams of methods for determining user interface feeds according to embodiments.

FIG. 6 shows an exemplary user interface of an application for a food delivery service.

FIG. 7 shows a flow diagram of a method for ranking a user interface feed according to embodiments.

FIG. 8 shows a user interface feed before and after being ranked and adjusted by embodiments.

### DETAILED DESCRIPTION

Prior to discussing specific embodiments of the invention, some terms can be described in further detail.

A “user” may include an individual. In some embodiments, a user may be associated with one or more personal accounts and/or mobile devices. In some embodiments, the user may be a consumer.

A “user device” may be any suitable electronic device that can process and communicate information to other electronic devices. The user device may include a processor, and a computer-readable medium coupled to the processor, the computer-readable medium comprising code, executable by the processor. The user device may also each include an external communication interface for communicating with other entities. Examples of user devices may include a mobile device, a laptop or desktop computer, a wearable device, etc.

A “server computer” is typically a powerful computer or cluster of computers. For example, the central server computer can be a large mainframe, a minicomputer cluster, or a group of servers functioning as a unit. In one example, the central server computer may be a database server coupled to a Web server. The central server computer may also be a cloud based server.

A “transporter” can be an entity that transports something. For example, a transporter can be a person that transports an item using a transporter vehicle (e.g., a car). In other embodiments, a transporter can be a transporter vehicle that may or may not be operated by a human. Examples of transporter vehicles include cars, boats, scooters, bicycles, drones, airplanes, etc.

A “fulfillment request” can be a request to provide a resource in response to a request. For example, a fulfillment request can include an initial communication from an end user device to a central server computer for a first service provider computer to fulfill a purchase request for a resource such as food. A fulfillment request can be in an initial state, a partially completed state, or a final state. After the fulfillment request is in a final state, it can be accepted by the central server computer, and the central server computer can send a fulfillment request confirmation to the end user device. A fulfillment request can include one or more selected items from a selected service provider. A fulfillment request can also include user features of the end user providing the fulfillment request.

A “cart” can include software that records items selected by a user for purchase until a transaction is completed. A cart can be an ecommerce shopping cart, which can be a type of software that allows end users to purchase items from a service provider or store a list of items the end user wants to purchase in the future. A cart including one or more items can be generated by a central server computer.

An “item” can include an individual article or unit. An item can be a thing that is provided by a service provider. Items can be a goods. For example, an item can be a bowl of soup, a soda can, a toy, clothing, etc. An item can be a thing that is delivered from a service provider location to an end user location by a transporter.

A “feature” can be an individual measurable property or characteristic of a phenomenon. A feature can be described by a feature vector. A feature can be input into a model to determine an output. As an example, in pattern recognition and machine learning, a feature vector is an n-dimensional vector of numerical features that represent some object. Algorithms in machine learning require a numerical representation of objects since such representations facilitate processing and statistical analysis. When representing images, the feature values might correspond to the pixels of an image. When representing text, however, the features might be the frequencies of occurrence of textual terms. Feature vectors are equivalent to the vectors of explanatory variables used in statistical procedures such as linear regression. Feature vectors can be combined with weights using a dot product in order to construct a linear predictor function that is used to determine a score for making a prediction.

“User features” can include attributes or aspects of a user. User features can include features that relate to a user. User features can include order history, delivery location, dietary preferences, user ratings, user comments, user feedback, saved service providers, favorited service providers, a current location, food category preferences, delivery time thresholds (e.g., delivery within 1 hour, 45 minutes, etc.), budget preferences, and/or other data representative of, or input by, the user.

“Service provider features” can include attributes or aspects of a service provider. Service provider features can include features that relate to a service provider. Service provider features can include service provider details, cuisine, ratings, food category, service provider location(s), item production time, promoted items, item cost, and/or other data representative of the service provider and/or items provided by the service provider.

“Machine learning” can include an artificial intelligence process in which software applications may be trained to make accurate predictions through learning. The predictions can be generated by applying input data to a predictive model formed from performing statistical analyses on aggregated data. A model can be trained using training data, such that the model may be used to make accurate predictions. The prediction can be, for example, a classification of an image (e.g., identifying images of cats on the Internet) or a recommendation (e.g., a movie that a user may like or a restaurant that a consumer might enjoy).

A “model” can include a computer program that is designed to simulate what might occur in a situation given various inputs. A model can be a machine learning model. A model can receive input data and determine an output. User features and service provider features can be input into a model to determine an output of a cart.

A “machine learning model” may include an application of artificial intelligence that provides systems with the ability to automatically learn and improve from experience without explicitly being programmed. A machine learning model may include a set of software routines and parameters that can predict an output of a process (e.g, identification of an attacker of a computer network, authentication of a computer, a suitable recommendation based on a user search query, etc.) based on feature vectors or other input data. A structure of the software routines (e.g., number of subroutines and the relation between them) and/or the values of the parameters can be determined in a training process, which can use actual results of the process that is being modeled, e.g., the identification of different classes of input data Examples of machine learning models include support vector machines (SVM), models that classify data by establishing a gap or boundary between inputs of different classifications, as well as neural networks, collections of artificial “neurons” that perform functions by activating in response to inputs.

A “processor” may include a device that processes something. In some embodiments, a processor can include any suitable data computation device or devices. A processor may comprise one or more microprocessors working together to accomplish a desired function. The processor may include a CPU comprising at least one high-speed data processor adequate to execute program components for executing user and/or system-generated requests. The CPU may be a microprocessor such as AMD's Athlon, Duron, and/or Opteron; IBM and/or Motorola's PowerPC; IBM's and Sony's Cell processor; Intel's Celeron, Itanium, Pentium, Xeon, and/or XScale; and/or the like processor(s).

A “memory” may be any suitable device or devices that can store electronic data. A suitable memory may comprise a non-transitory computer readable medium that stores instructions that can be executed by a processor to implement a desired method. Examples of memories may comprise one or more memory chips, disk drives, etc. Such memories may operate using any suitable electrical, optical, and/or magnetic mode of operation.

Embodiments of the invention use real-time, client-side device data to predict user agitation and perform an action such as adjusting a user interface on a client side user device. Unlike traditional systems that rely on aggregated or delayed server-side data, embodiments allow for actions including instantaneous display adjustments, such as rearranging content, prioritizing faster delivery options, or presenting targeted promotions on a user device, based on the user's current mental state. In other embodiments, actions that result from determining that the user is in a frustrated state may relate to diverting the user device to a different resources. For example, a user that is frustrated with using a chatbot may be automatically directed to a human service representative if the user is determined to be frustrated.

In an example, when a user opens an application (e.g., a food delivery application) on their user device (e.g., a mobile phone), the application may collect real-time client device data as the user navigates the application. For example, while the user scrolls through food options, the application can record real-time client device data. The application can determine an agitation score based on the real-time client device data. The agitation score can further be used to determine items to display in a feed to a user.

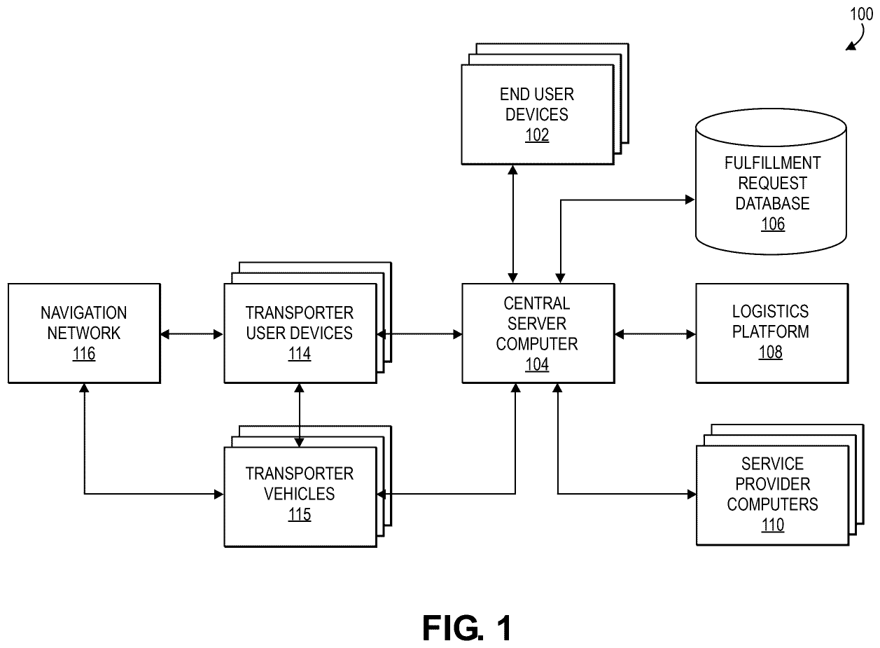

FIG. 1 shows a system 100 according to embodiments of the disclosure. The system 100 in FIG. 1 can include one or more end user device 102 operated by end user, a central server computer 104, a fulfillment request database 106, a logistics platform 108, one or more service provider computers 110, one or more transporter user devices 114, one or more transporter vehicles 115, and a navigation network 116. The end user devices 102 may determine the agitation scores according to embodiments and can perform actions based on the agitation scores. Transporters can pick up orders from merchants (e.g., service providers) and deliver resources to end users that operate end user devices 102.

The central server computer 104 can be in operative communication with the one or more end user devices 102, the fulfillment request database 106, the logistics platform 108, the one or more service provider computers 110, the transporter user device 114, the transporter vehicles 115, and in some embodiments, the navigation network 116. Further, the one or more transporter user devices 114 can be in operative communication with the navigation network 116. In some embodiments, the transporter vehicles 115 can be in operative communication with the navigation network 116. The processing computer 118 can be in operative communication with the end user devices 102 and the transporter user devices 114.

The entities in FIG. 1 may communicate using any suitable communications networks. Suitable communications networks may be any one and/or the combination of the following: a direct interconnection; the Internet; a Local Area Network (LAN); a Metropolitan Area Network (MAN); an Operating Missions as Nodes on the Internet (OMNI); mesh networks, a secured custom connection; a Wide Area Network (WAN); a wireless network (e.g., employing protocols such as, but not limited to a Wireless Application Protocol (WAP), I-mode, and/or the like); and/or the like

The one or more end user devices 102 includes devices operated by end users. The one or more end user devices 102 can generate and provide fulfillment request messages to the central server computer 104. The fulfillment request message can indicate that the request (e.g., a request for a service) can be fulfilled by one or more service provider computers 110. For example, the fulfillment request message can be generated based on a cart selected at checkout during a transaction using a central server computer application installed on the end user device 102. The fulfillment request message can include one or more items from the selected cart.

In an example, the fulfillment request message can be a request for a food item (e.g., a hamburger) to be prepared by a specific service provider computer 110 and delivered to an end user location by a transporter that operates a transporter user device and, in some embodiments, a transporter vehicle.

The end user device 102 can provide a fulfillment request message to the central server computer 104 that indicates that the end user device 102 is requesting that a transporter operating a transporter user device 114 pick up an item from a pickup location and deliver the item to a drop-off location. The pickup location can be a location in which items are stored. In the context of an outbound delivery from an end user at an end user location, examples of the pickup location may be a house or an apartment, a mailbox, a service provider location (e.g., a retail store, a grocery store, a dry cleaning store), a pickup hub, etc. Items can first be obtained from a pickup location and then be transported to the drop-off location. Examples of the drop-off location can be similar to the pickup location, such as a house or apartment, a mailbox, a retail store, a grocery store, a dry cleaning store, a pickup hub, etc. In one example, the pickup location can be a pizza parlor from which the end user orders a pizza. The drop-off location can be an apartment in which the end user resides.

The central server computer 104 can facilitate the fulfillment of fulfillment requests received from the one or more end user devices 102. For example, the central server computer 104 can identify one or more transporters operating one or more transporter user devices 114 that are capable of satisfying the fulfillment request. The central server computer 104 can identify the transporter user device 114 that can satisfy the fulfillment request based on any suitable criteria (e.g., transporter location, service provider location, end user destination, end user location, transporter mode of transportation, etc.). The logistics platform 108 may provide real time data regarding locations of the various service providers, transporters, and end users to the central server computer 104.

The central server computer 104 can receive data relating to a delivery order of items from the service provider computer 110 to the end user of the end user device 102 at a drop-off location. The central server computer 104 can determine a route for delivery of the delivery order. The central server computer 104 can present the routes to a plurality of transporter user devices 114 and/or transporters. The central server computer 104 can receive acceptances from a transporter user device that will deliver the items from a pickup location to the drop-off location.

The central server computer 104 can receive data from user devices. For example, the central server computer 104 can receive fulfilment data, image data, item data, etc. from the transporter user device 114. The central server computer 104 can also receive data from the end user device 102. The central server computer 104 can store the data into a database.

The central server computer 104 can maintain and update item listings that can be accessible in a delivery application managed by the central server computer 104. The delivery application can be installed on end user devices and can allow end users to select items from the item listings to have delivered to the end user from a service provider location by a transporter. In some embodiments, the central server computer 104 can update item listings based on item information data entries in an item information database.

The logistics platform 108 can include a location determination system, which can determine the locations of various user devices such as the transporter user devices 114 and the end user devices 102. The logistics platform 108 can also include routing logic to efficiently route transporters using the transport user devices to various pickup locations that have the packages that are to be delivered to drop-off locations. Efficient routes can be determined based on the locations of the transporters, the locations of the pickup locations, the locations of the drop-off locations, as well as external data such as traffic patterns, the weather, etc. The logistics platform 108 can be part of the central server computer 104 or can be a system that is separate from the central server computer 104.

The fulfillment request database 106 can store data related to previous (e.g., historical) fulfillment requests. For example, after a fulfillment request is fulfilled, the central server computer 104 can store fulfillment request data into the fulfillment request database 106. For example, the central server computer 104 can store any spatial-temporal fulfillment data (e.g., transporter user device location over time, transporter user device motion data over time, length of time taken to fulfil the fulfillment request, a fulfillment time, a fulfillment location, etc.), fulfillment service data (e.g., fulfilled services, an amount, a service provider computer identifier, an end user device identifier, a transporter user device identifier, etc.), and any other data relating to the fulfillment request and/or the fulfillment of the fulfillment request.

The one or more service provider computers 110 include computers operated by service providers. For example, a service provider computer can be a food provider computer that is operated by a food provider. The one or more service provider computers 110 can offer to provide services to the end users of the one or more end user devices 102. The service provider computer 110 can receive requests to prepare one or more items for delivery from the central server computer 104. The service provider computer 110 can initiate the preparation of the one or more items that are to be delivered to the end user of the end user device 102 by a transporter of a transporter user device 114.

The one or more transporter user devices 114 can be devices operated by transporters. The one or more transporter user devices 114 can be smartphones, wearable devices, personal assistant devices, etc. The transporter user device 114 can respond to the central server computer 104 with an indication that the transporter operating the transporter user device 114 will perform the delivery to the end user as indicated by the fulfillment request. In some embodiments, the one or more transporter user devices 114 are communication devices in autonomous vehicles.

In some embodiments, a transporter can operate a transporter user device 114 and a transporter vehicle 115. For example, a transporter can be a delivery person, the transporter user device 114 can be the delivery person's mobile phone, and the transporter vehicle 115 can be a car that is operated by the delivery person. The transporter vehicles 115 can include cars, bikes, mopeds, skateboards, public transit vehicles, etc. In some embodiments, a transporter may not utilize a transporter vehicle 115 (e.g., the transporter can deliver the items of the fulfillment request by foot).

In some embodiments, the central server computer 104 can identify the transporter vehicle 115 that can satisfy the fulfillment request based on any suitable criteria (e.g., transporter vehicle location, transporter vehicle type, transporter vehicle battery charge level, transporter vehicle weight limit, service provider location, end user destination, end user location, etc.). The transporter vehicles 115 can include autonomous vehicles that can operate without receiving input from a transporter.

The navigation network 116 can provide navigational directions to the one or more transporter user devices 114. For example, the transporter user device 114 can obtain a location from the central server computer 104. The location can be a service provider parking location, a service provider location, an end user parking location, an end user location, etc. The navigation network 116 can provide navigational data to the location. For example, the navigation network 116 can be a global positioning system that provides location data to the transporter user device 114. In some embodiments, the transporter vehicle 115, which can be an autonomous vehicle, can communicate with the navigation network 116 to automatically direct or route the transporter vehicle 115 to the destination.

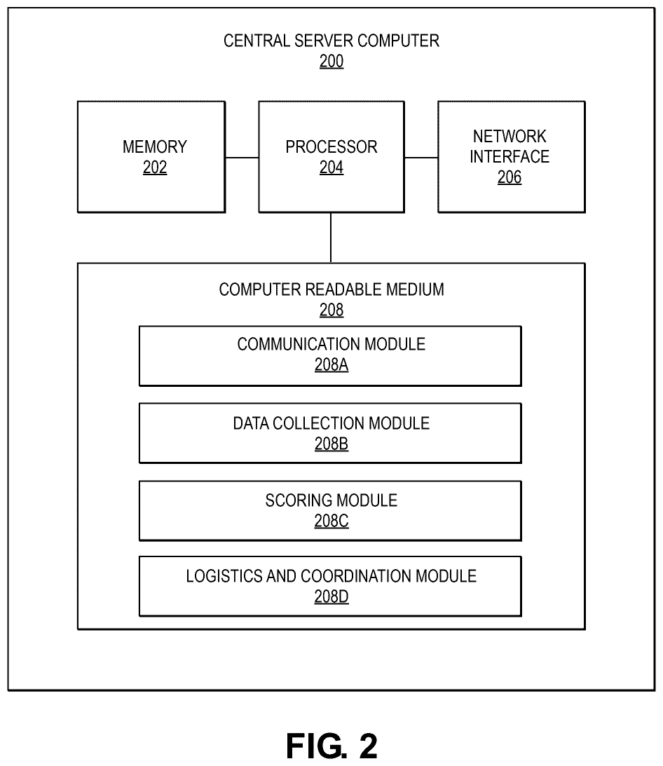

FIG. 2 shows a block diagram of a central server computer 200 according to embodiments. The exemplary central server computer 200 may comprise a processor 204. The processor 204 may be coupled to a memory 202, a network interface 206, and a computer readable medium 208. The computer readable medium 208 can comprise one or more modules. The computer readable medium 208 can comprise a communication module 208A, a data collection module 208B, a scoring module 208C, and a logistics and coordination module 208D.

The memory 202 can be used to store data and code. For example, the memory 202 can store fulfilment data, historical data, chat data, etc. The memory 202 may be coupled to the processor 204 internally or externally (e.g., cloud based data storage), and may comprise any combination of volatile and/or non-volatile memory, such as RAM, DRAM, ROM, flash, or any other suitable memory device.

The memory 202 can also have a computer readable medium comprising code, executable by the processor 204 to perform a method comprising: receiving, from the user device, a fulfillment request message comprising at least an item associated with the image, wherein the image is presented to the user based on agitation score; providing the fulfillment request message to a service provider computer operated by the service provider, wherein the service provider initiates preparation of at least the item; determining one or more transporter user devices; providing the fulfillment request message to the one or more transporter user devices, wherein the one or more transporter user devices determine whether or not to request to accept the fulfillment request message; receiving an acceptance message from a transporter user device of the one or more transporter user devices; generating an update message indicating a status of the fulfillment request message; and providing the update message to the end user device.

The network interface 206 may include an interface that can allow the central server computer to communicate with external computers. The network interface 206 may enable the central server computer 104 to communicate data to and from another device (e.g., one or more user devices, one or more transporter user devices, etc.). Some examples of the network interface 206 may include a modem, a physical network interface (such as an Ethernet card or other Network Interface Card (NIC)), a virtual network interface, a communications port, a Personal Computer Memory Card International Association (PCMCIA) slot and card, or the like. The wireless protocols enabled by the network interface 206 may include Wi-Fi™. Data transferred via the network interface 206 may be in the form of signals which may be electrical, electromagnetic, optical, or any other signal capable of being received by the external communications interface (collectively referred to as “electronic signals” or “electronic messages”). These electronic messages that may comprise data or instructions may be provided between the network interface 206 and other devices via a communications path or channel. As noted above, any suitable communication path or channel may be used such as, for instance, a wire or cable, fiber optics, a telephone line, a cellular link, a radio frequency (RF) link, a WAN or LAN network, the Internet, or any other suitable medium.

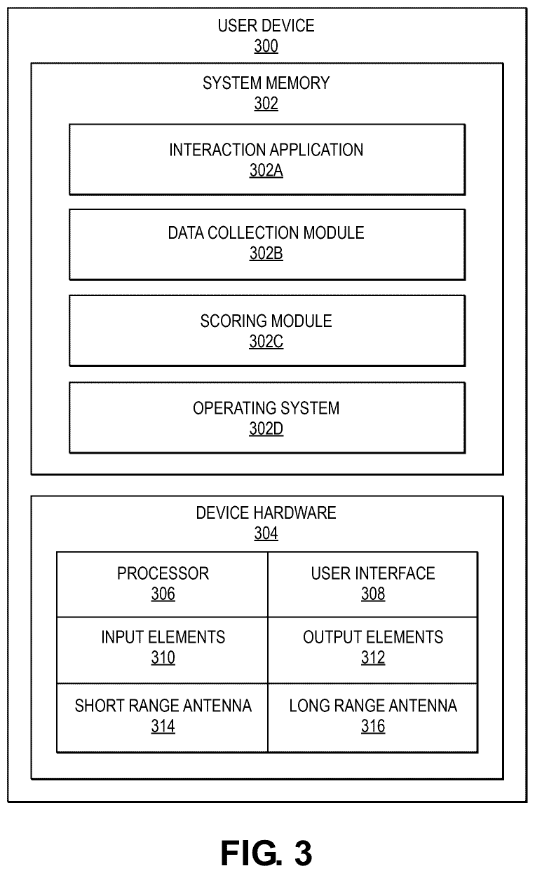

FIG. 3 illustrates a user device 300 according to an embodiment. The user device 300 may include device hardware 304 coupled to a system memory 302.

Device hardware 304 may include a processor 306, a short range antenna 314, a long range antenna 316, input elements 310, a user interface 308, and output elements 312 (which may be part of the user interface 308). Examples of input elements may include microphones, keypads, touchscreens, sensors, etc. Examples of output elements may include speakers, display screens, and tactile devices. Exemplary input elements can include accelerometers, gyroscopes, touch screens, buttons, etc. The device hardware 304 may also include a GPS module, which can determine a GPS location of the user device 300.

The processor 306 can be implemented as one or more integrated circuits (e.g., one or more single core or multicore microprocessors and/or microcontrollers) and is used to control the operation of the user device 300. The processor 306 can execute a variety of programs in response to program code or computer-readable code stored in the system memory 302 and can maintain multiple concurrently executing programs or processes.

The long range antenna 316 may include one or more RF transceivers and/or connectors that can be used by the user device 300 to communicate with other devices and/or to connect with external networks. The user interface 308 can include any combination of input and output elements to allow a user to interact with and invoke the functionalities of the user device 300. The short range antenna 314 may be configured to communicate with external entities through a short range communication medium (e.g., using Bluetooth, Wi-Fi, infrared, NFC, etc.). The long range antenna 316 may be configured to communicate with a remote base station and a remote cellular or data network, over the air.

The system memory 302 can be implemented using any combination of any number of non-volatile memories (e.g., flash memory) and volatile memories (e.g., DRAM, SRAM), or any other non-transitory storage medium, or a combination thereof media. The system memory 302 may store computer code, executable by the processor 306, for performing a non-transitory computer readable medium storing a plurality of instructions that, when executed, cause the processors to perform a method comprising: retrieving, by the user device from a database on the user device, historical data, and real-time client device data; determining, by the user device, an agitation score based on the real-time client device data and the historical data; and performing, by the user device, an action based on the agitation score.

The system memory 302 may also store an interaction application 302A, a data collection module 302B, a scoring module 302C, and an operating system 302D.

The interaction application 302A and the processor 306 can facilitate various interactions such as food delivery orders, payment transactions, etc. The interaction application 302A and the processor 306 can also perform actions in response to agitation scores determined by the scoring module 302C.

The data collection module 302B and the processor 306 can collect data as described herein. For example, the data collection module 302B and the processor 306 may collect data from the input elements 310, internal power sources, external data sources, etc.

The scoring module 302C and the processor 306 can perform scoring as described herein and below. In some embodiments, the scoring module 302C and the processor 306 can calculate an agitation score as described below.

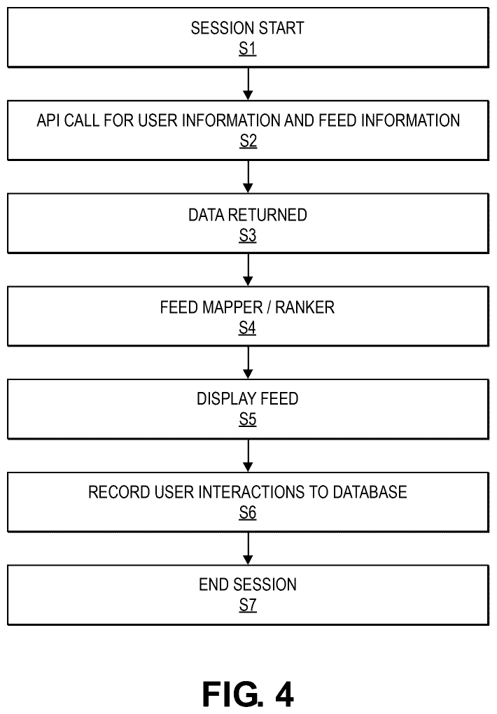

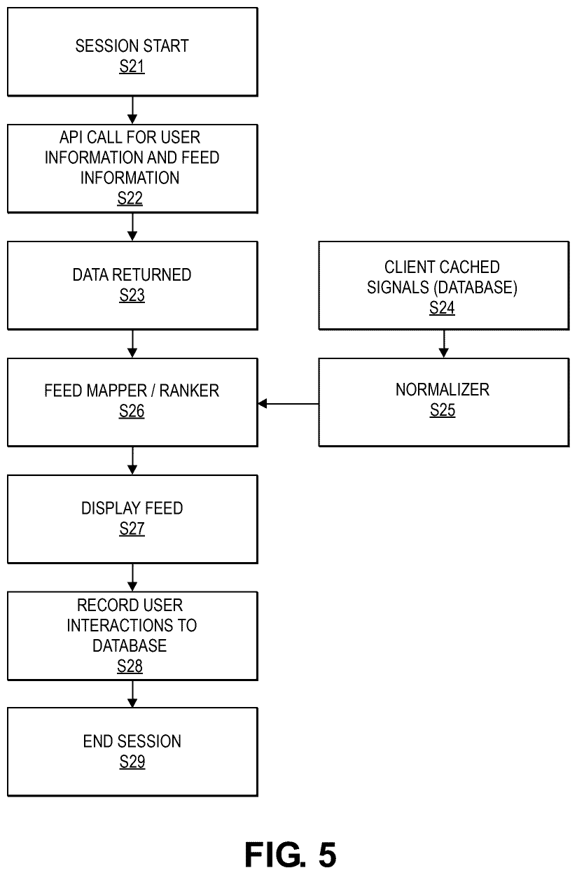

FIGS. 4-5 shows a flow diagrams of methods for determining user feeds according to embodiments. FIG. 4 shows a first flow for a first time user, and FIG. 5 shows a second flow for an existing user.

At step S1, the session initiation process is triggered when a user, without any pre-existing client-side data, begins interacting with the system using a user device such as a mobile phone. This process involves initializing necessary components and establishing a connection between the user device and a server computer. This typically occurs when the user logs into an application on the user device, and user identifiers are obtained. The user may log in using application on a user device, and the application may send the user identifiers to the server computer.

At step S2, the application sends an API request to the server computer to retrieve user-specific information and content feed data (e.g., data for available restaurants and items). This step may enable tailoring the user experience based on available data and context.

At step S3, the server computer processes the API request and returns relevant data, including the content feed data that is curated or generated based on default parameters, if the user has no pre-existing data.

At step S4, after receiving the response from the server computer, the application may rank the content. For example, the application may use a feed mapper/ranker, which may be a software module in the application on the user device, organize and prioritize content on the user device. This ensures the content is displayed in a meaningful order to the user.

At step S5, the application displays the organized feed data on the user interface, making the content accessible for user interaction. The presentation of this feed is designed to engage the user.

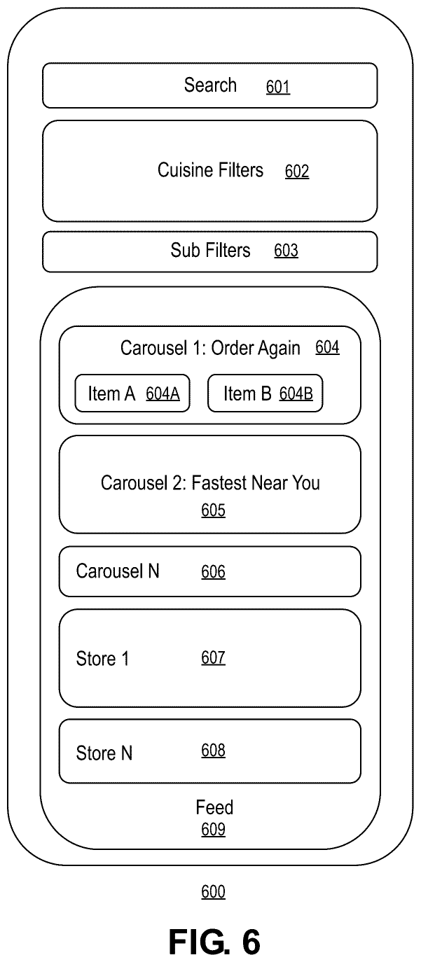

FIG. 6 shows an exemplary user interface of an application on a user device. The application may be associated with and managed by a food delivery service organization. For example, a user may open the application and look for food to order. Embodiments can optimize the layout of the user interface 600 to enhance the user experience, as described above. Users can navigate the user interface 600 to search, filter, and browse food options before placing an order. The layout is segmented into distinct sections which may guide users from initial search to final order placement. The user interface 600 may comprise a search bar 601, cuisine filters 602, sub filters 603, and a feed 609. Embodiments can optimize the layout of the user interface 600 to enhance the user experience, as described above.

Positioned at the top of the interface, the search bar 601 allows users to input queries directly, enabling them to find specific restaurants, cuisines, or menu items quickly. The search bar 601 functionality may be applicable for users who know exactly what they want and prefer a direct route to access it.

Below the search bar, cuisine filters 602 offers users predefined filters categorized by cuisine type (e.g., Italian, Chinese, Fast Food). Users can narrow down their options by selecting one or more cuisine types, streamlining their browsing experience, and focusing on their preferences.

Sub filters 603 provides additional filtering options based on specific criteria such as price range, delivery time, or dietary preferences. Sub filters are intended to refine search results further, enabling users to tailor the list of available options to meet their exact needs.

The feed 609 can be a continuous stream of content displaying restaurant listings, carousels, and other promotional items. This section can be where users often spend the majority of their browsing time. In the exemplary user interface 600, the feed 609 may comprise N carousels as indicated by first carousel 604, second carousel 605, and Nth carousel 606; and N stores as indicated by the first store 607 and Nth store 608. In embodiments of the disclosure, the feed 609 may differ between users to accommodate their individual needs.

The first carousel 604 displays a horizontal list of items labeled “Order Again.” The first carousel 604 is dynamically populated with previously ordered items (e.g., item 604A and item 604B), allowing users to quickly reorder favorites with minimal effort. The presence of past orders is particularly useful for frequent users.

The second carousel 605 showcases restaurants or items that can be delivered quickly, catering to users who prioritize speed. The items are ranked by estimated delivery time, addressing the needs of users who are in a hurry.

The Nth carousel 606 is a section where additional carousels may be added to display other relevant categories or promotions, such as “Top Rated” or “Discounted Items.” The flexibility of adding multiple carousels ensures that users are continuously presented with varied and potentially appealing options.

The first store 607 may be an individual store or restaurant listing. The first store 607 entry may include essential information such as name, rating, and a brief description. Users can click on the first store 607 to view its full menu, further details, and place an order.

Store N 608 may be additional store or restaurant listings, similar in function to the first store 607. The layout supports scrolling through multiple listings, giving users a broad view of available options in their area.

There are a number of ways that users can interact with the user interface 600 while browsing. For example, a user may click (by a physical click of a button), or touch a carousel item to transition to the cart or store page. In another example, a user can swipe from one cart to another to review the item or store displayed, and any promotional offers associated with them.

Referring back to the flow of FIG. 4, at step S6, as the user interacts with the displayed content, the application can record real-time client device data store it in a database (e.g., a cache). The real-time client device data may comprise a number of parameters associated with the interactions. In embodiments of the invention, the application may use the real-time client device data to assess user agitation and adjust the feed accordingly, in the same session or future sessions. For example, the real-time client device data may be used to determine an agitation score, which may be used by the application's feed ranking system. Table 1 below describes 16 signal parameters and how they may correlate to user agitation. The signal parameters below may be examples of real-time client device data. There may be more or less signal parameters in embodiments of the invention.

TABLE 1

| N | Parameter | Description | Correlation |
|---|---|---|---|
| 1 | Scroll Speed (SS) | The speed at which the | When users are |
| | | user is scrolling through | frustrated, they tend to |
| | | the feed (in pixels per | scroll faster and more |
| | | second). | erratically - struggling to |
| | | | find what they want. |
| 2 | Scroll Duration (SD) | The total duration the | This extended duration |
| | | user spends scrolling (in | can be indicative of |
| | | seconds). | rising frustration, |
| | | | particularly if the user |
| | | | cannot easily find |
| | | | something that appeals |
| | | | to them. |
| 3 | Pause Frequency (PF) | The number of pauses | Frequent pauses during |
| | | the user makes while | scrolling may indicate |
| | | scrolling. | that the user is |
| | | | experiencing decision |
| | | | fatigue. |
| 4 | Pause Duration (PD) | The average duration of | Pauses can be longer |
| | | each pause (in | and more frequent as |
| | | seconds). | hunger impairs their |
| | | | ability to decide quickly. |
| 5 | Click-through Rate | The ratio of clicks on | A low CTR may indicate |
| | (CTR) | restaurant listings to the | that the user is viewing |
| | | number of listings | many options but not |
| | | viewed. | finding anything |
| | | | appealing enough to |
| | | | click - suggest |
| | | | dissatisfaction or |
| | | | indecision. |
| 6 | Time of Last Order (TLO) | The number of hours | A long TLO indicates |
| | | since the user's last | the returning user is |
| | | recorded order (if | probably hungry or a |
| | | available). | new user is hungry and |
| | | | ready to order. |
| 7 | Frustration Signals (FS) | Includes abrupt or jerky | Multiple feed / store |
| | | scrolling patterns, | page interactions |
| | | repeated back-and-forth | without conversion |
| | | like Feed -> Store Page. | (adding to cart) |
| | | | indicates frustration. |
| 8 | Scroll Depth (SDP) | Depth of scrolling | Large scroll depth |
| | | defined as page / offset | indicates frustration for |
| | | parameters. | finding items. |
| 9 | Previous Interactions | Previous Session Time. | Previous session time <1 |
| | (PI) | | h might indicate |
| | | | escalating hunger and |
| | | | growing impatience. |
| | | | This escalation in |
| | | | session frequency |
| | | | suggests that the user's |
| | | | hunger is becoming |
| | | | more urgent. |
| 10 | Store Conversion | (# explore page loads / # | Clicking on stores |
| | | store page loads). | indicates a clear intent |
| | | | to find something to |
| | | | order soon not just |
| | | | browsing. |
| 11 | Cart Conversion | (# of cart page visits / # | Moving from the feed to |
| | | explore page loads). | the store page and then |
| | | | to the cart suggests a |
| | | | clear and urgent intent |
| | | | to purchase. |
| 12 | Checkout Conversion | (# of explore page visits /# | When a user progresses |
| | | checkout page visits). | all the way to the |
| | | | checkout, it strongly |
| | | | suggests that their need |
| | | | (in this case, hunger) is |
| | | | urgent and they are |
| | | | ready to finalize the |
| | | | transaction. This is a |
| | | | clear sign of hunger. |
| 13 | Search Signals | # of searches made in a | Intent to find a store / |
| | | session. | particular item to |
| | | | checkout. |
| 14 | Battery Level | Device Battery Level | When a user's battery |
| | | % age. | level is low, they may |
| | | | feel an added sense of |
| | | | urgency to complete |
| | | | their task before their |
| | | | device powers down. If |
| | | | the user is also hungry, |
| | | | this urgency can amplify |
| | | | their desire to order food |
| | | | quickly. The |
| | | | combination of hunger |
| | | | and a low battery might |
| | | | push the user to make |
| | | | faster decisions. |
| 15 | Location | Home / Away. | A location such as a |
| | | | work location or an |
| | | | airport might be |
| | | | indicative of higher |
| | | | intent to order. |
| 16 | New User | Indicates when account | |
| | | was created and if the | |
| | | user is categorized as | |
| | | “new.” | |

At step S7, the application may end the session. Upon completion of the user session, the session is terminated, and any final actions are processed, such as saving session data and clearing temporary caches. For example, the user may close the application or sign out of the application.

In FIG. 5, the second flow illustrates a method for curating a user interface for an existing user according to embodiments. At step S21, the application can initialize a session for an existing user who has pre-existing data stored on the client user device or the server computer.

At step S22, the application sends an API request to the server computer to retrieve updated user-specific information and content feed data, potentially leveraging existing user data for a more personalized response.

At step S23 the server computer processes the request and returns data, which includes not only the content feed but also additional user-specific information or signals that have been collected or inferred during previous interactions. This enriched data is used to enhance personalization.

At steps S24-S25, client cached signals are normalized and passed to the feed mapper using a normalizer, which processes user data or signals. Standardizing and normalizing these inputs ensures consistency across different sessions and devices. This step ensures that the data used for feed mapping/ranking is reliable and comparable. For example, client cached signals may comprise data from a past session, which is described above in step S6. The client cache signals may come from a client database. The client database may be a database or storage system where user signals (such as preferences, interaction history, etc.) are cached on the client-side. This cached data can be used to expedite the session startup process and improve the responsiveness of the content delivery system.

At step S26, the returned data from the server computer, which may include both content feed and user-specific signals, and the client cached signals are processed by a feed ranker. The system orders the content according to the user's preferences, behavior, and other contextual factors.

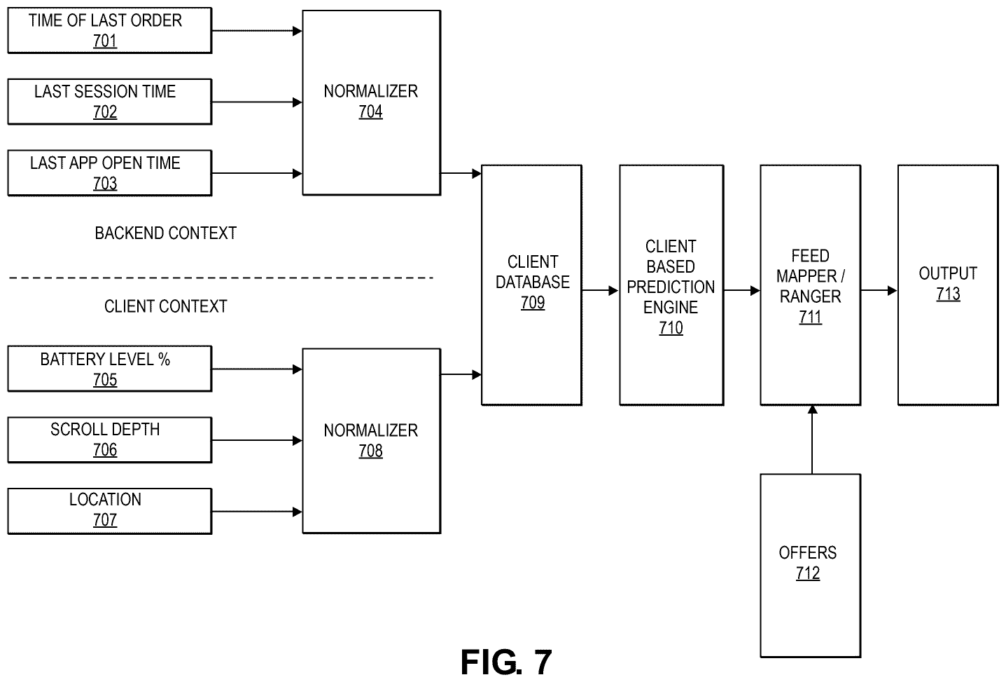

FIG. 7 shows a flow diagram of a method for ranking a user interface feed according to embodiments. FIG. 7 outlines a decision-making framework designed to dynamically adjust the content and recommendations presented to users in an application, such as a food delivery app, based on various contextual signals. The framework integrates multiple user and device signals through normalization and predictive algorithms to enhance the relevance and timeliness of the content presented.

N potential parameters are sent from the backend as signals, as described above in steps S3 and S23 of FIGS. 4-5. These are illustrated in the diagram as examples such as Time of Last Order 701, Last Session Time 702, Last App Open Time 703, Is New User etc. The backend signals may be stored normalized. For example, a normalizer 704 processes the backend context signals (TLO, Last Session Time, Last App Open Time) to standardize these inputs to a normalized value between 0 to 1 or to a discrete preset enumerated value that is fed as a signal to prediction algorithm. The normalized backend signals may be stored in a client database 709 on the user device.

N potential parameters from the user device such as the signals listed may also be considered. For example, as described in step S6 above, real-time client device data from a past session or the current session may be stored. For illustrative purposes battery level 705, scroll depth 706 and location 707 are mentioned. A client data normalizer 708 may convert the raw data into standardized metrics that can be consistently applied across different user contexts. For example, to normalize each value between 0 and 1, embodiments can first determine the possible minimum and maximum values for each parameter. These ranges allow us to map the actual values onto a normalized scale. An example equation (1) is below.

$$Normalization = ( Actual Value - Minimum Value ) / ( Max - Min ) Value \qquad ( 1 )$$

The client database 709 stores both real-time and historical user data, including past interactions, preferences, and normalized context signals. This database serves as the foundational data source for the prediction engine and feed mapping processes. It provides the necessary background information to tailor the user experience effectively.

The prediction engine 710 uses the normalized data from both backend and client contexts, along with historical data from the client database, to predict the user's current needs and likely behavior. This can be as complex as an on device machine learning model or an algorithm with weights. An exemplary description of this is provided below.

To quantify user agitation, a weighted formula can be used, incorporating multiple signals that indicate frustration and hunger. The weighted formula weights each real-time client device data parameter from Table 1 above. The formula is as follows:

$$User agitation = ( w 1 * SS ) + ( w 2 * SD ) + ( w 3 * PF ) + ( w 4 * PD ) + ( w 5 * CTR ) + ( w 6 * TLO ) + ( w 7 * FS ) + ( w 8 * SDP ) + ( w 9 * PI ) + ( w 10 * SC ) + ( w 11 * CC ) + ( w 12 * ChC ) + ( w 13 * SSig ) + ( w 14 * BL ) + ( w 15 * Loc ) + ( w 16 * NU )$$

The determination of these weights (w1, w2, w3, . . . , w16) may be static (e.g., hardcoded) or dynamic based on the situation of the client with the help of a ML (machine learning) model. Each weight can adjust the influence that each real-time client device data parameter has on the agitation score.

To produce an agitation score, the application can normalize the real-time client device data parameters, and input them into the weighted formula. To illustrate, an agitation score is determined for a session with the following real-time client device data parameters:
Scroll Speed (SS): 300 pixels/second.
Scroll Duration (SD): 180 seconds
Pause Frequency (PF): 8 pauses
Pause Duration (PD): 3 seconds per pause
Click-through Rate (CTR): 0.1 (10% of listings clicked)
Time of Last Order (TLO): 5 hours.
Frustration Signals (FS): 2 (detected jerky scrolling patterns).
Scroll Depth (SDP): 5 pages.
Previous Interactions (PI): Recent session within the last hour
Store Conversion (SC): 0.5
Cart Conversion (CC): 0.2
Checkout Conversion (ChC): 0.1
Search Signals (SSig): 3 searches
Battery Level (BL): 20%.
Location (Loc): Away from home (e.g., at work)
New User (NU): No

The real-time client device data parameter has the following assumed ranges for normalization:
Scroll Speed (SS): 0 to 1000 pixels/second
Scroll Duration (SD): 0 to 300 seconds
Pause Frequency (PF): 0 to 20 pauses.
Pause Duration (PD): 0 to 10 seconds
Click-through Rate (CTR): 0 to 1 (0% to 100%).
Time of Last Order (TLO): 0 to 24 hours.
Frustration Signals (FS): 0 to 5 signals.
Scroll Depth (SDP): 0 to 20 pages.
Previous Interactions (PI): 0 to 24 hours (based on time since last interaction).
Store Conversion (SC): 0 to 1.
Cart Conversion (CC): 0 to 1.
Checkout Conversion (ChC): 0 to 1
Search Signals (SSig): 0 to 10 searches
Battery Level (BL): 0% to 100%.
Location (Loc): Binary (0=Home, 1=Away).
New User (NU): Binary (0=No, 1=Yes).
New User (NU): Binary (0=No, 1=Yes)

Table 2 below shows the corresponding normalized real-time device data.

TABLE 2

| Name | Normalized Value |
|---|---|
| Scroll Speed (SS) | 0.3 |
| Scroll Duration (SD) | 0.6 |
| Pause Frequency (PF) | 0.4 |
| Pause Duration (PD) | 0.3 |
| Click-through Rate (CTR) | 0.1 |
| Time of Last Order (TLO) | 0.2083 |
| Frustration Signals (FS) | 0.4 |
| Scroll Depth (SDP): 5 pages | 0.25 |
| Previous Interactions (PI) | 0.04 |
| Store Conversion (SC) | 0.5 |
| Cart Conversion (CC) | 0.2 |
| Checkout Conversion (CC) | 0.1 |
| Search Signals (SSig) | 0.3 |
| Battery Level (BL) | 0.2 |
| Location | 1 |

Using the normalized values and the weights provided:

$$Agitation score = ( 0.15 \times 0.3 ) + ( 0.05 \times 0.6 ) + ( 0.05 \times 0.4 ) + ( 0.05 \times 0.3 ) + ( 0.15 \times 0.1 ) + ( 0.25 \times 0.2083 ) + ( 0.10 \times 0.4 ) + ( 0.05 \times 0.25 ) + ( 0.05 \times 0.0417 ) + ( 0.10 \times 0.5 ) + ( 0.10 \times 0.2 ) + ( 0.15 \times 0.1 ) + ( 0.05 \times 0.3 ) + ( 0.10 \times 0.2 ) + ( 0.10 \times 1 ) + ( 0.05 \times 0 )$$

$$\{ Agitation score \} = 0.4537$$

The normalized agitation score for this example is approximately 0.4537. This value, which ranges between 0 and 1, indicates a moderate level of agitation based on the given user behavior and context. Depending on predefined thresholds, the application could use this agitation score to trigger certain actions, such as prioritizing quick delivery options, displaying special offers, or simplifying the ordering process to improve user experience and reduce frustration.

In some embodiments, certain combinations of the real-time client device data parameters can be prioritized, and the weights of the remaining signals may be ignored. For example, a first priority signal may be a combination of the battery level and location. If the battery is low and the location indicates the user is not home, the prediction engine 710 may predict urgency and determine a high agitation score. In another example, if the user has not ordered in a long time, their battery is low, and they are away from home, the prediction engine 710 may predict that the user needs to order quickly. In yet another example, a low battery combined with fast scrolling and a long time since the last order suggests the user is searching urgently for something to order.

The feed ranker 711 takes the predictions (e.g., an agitation score) from the prediction engine 710 and arranges the content in the user's feed. The feed ranker 711 prioritizes content based on relevance, urgency (e.g., hunger, battery life), and predicted engagement. For example, if the prediction engine 710 produces a high agitation score, the user may be likely to make quick decisions, and the feed ranker 711 should prioritize fast, easy-to-access options. The feed ranker 711 may prioritize items that can be quickly ordered and delivered so that they are displayed at the top of the feed in the user interface.

Promotional offers 712 integrates time-sensitive or contextually relevant promotions into the user's feed. These offers are selected based on their alignment with the normalized signals and predictions. Promotional offers are strategically placed within the feed to enhance user engagement and incentivize quick decision-making, particularly when urgency or a hesitation to check out is detected.

The final output 713 is a rearranged feed where each item, including both regular content (e.g., an open restaurant) and promotional offers, is assigned a relevance score between 0 and 1. These scores indicate how closely each item aligns with the user's current context and predicted needs, with 0 being the least relevant and 1 being the most relevant.

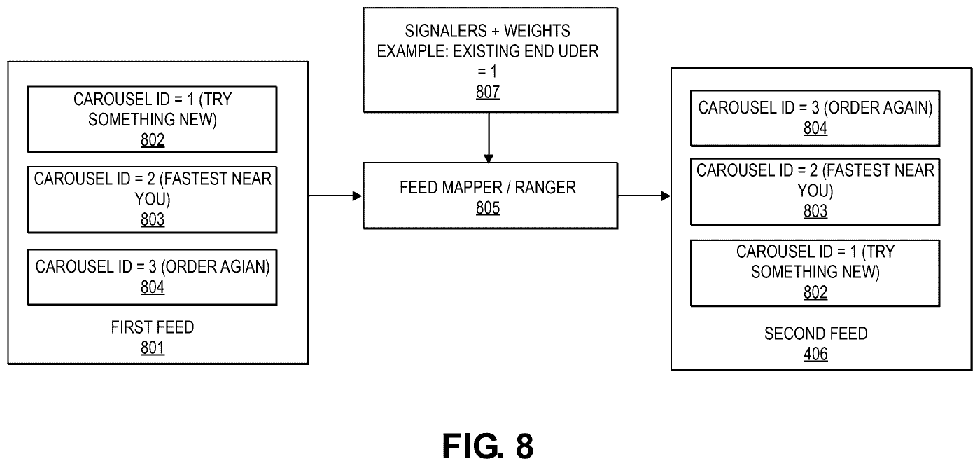

FIG. 8 shows a user interface feed before and after being ranked and adjusted by embodiments. The first feed 801 may be a generic feed of content data that has not been ranked. The first feed 801 may display the content with a first carousel 802 for new items at the top, a second carousel 803 for quick options, and a third carousel 804 for previous orders.

The second feed 806 shows the same content data as the first feed 801, reordered and optimized for the specific user. The feed ranker 805 may rank the content data from the first feed 801, and reorder it into the second feed 806. The feed ranker 805 may retrieve historical data and real-time client device data for the existing user, and determine an agitation score. Using the agitation score, the feed ranker 805 may assign relevance scores to each piece of content. Each piece of content can be displayed in order of its relevance score.

For instance, in a scenario where the user is likely hungry, the following relevance scores may be assigned:
1. Promotional Offer from a Nearby Pizza Place (Score: 0.95)
2. Offer for a Dessert from a Nearby Bakery (Score: 0.7)
3. Recipe for a Homemade Salad (Score: 0.4)
4. Distant Sushi Restaurant (Score: 0.2)
5. Article on Healthy Eating Habits (Score: 0.1)

In the example above, a promotional offer for the Nearby Pizza Place receives a relevance score of 0.95, while the Distant Sushi Restaurant scores only 0.2. The feed may be displayed based on these scores, ensuring that the most relevant items appear at the top, leading to a more efficient and satisfying user experience.

Referring back to the second flow in FIG. 5, at step S27 the organized and personalized feed is rendered on the user interface for the user to interact with, providing a tailored content experience.

At step S28, the application logs the session data into the database, further enriching the user's data profile and enhancing the accuracy of future content recommendations. For example, the session data may comprise real-time client device data.

At step S29, the session is closed, and any final actions such as saving data, logging out, or clearing session-specific caches are performed.

Although the agitation scores based on a hunger state of the user are described in detail, embodiments of invention are not limited thereto. For example, the agitation scores may also be based on a user's frustration state, such as when dealing with a chatbot or service provider that is unable to address the user's concerns. Also, although the delivery and/or the presentation of food items is described in detail, embodiments of the invention are not limited thereto. For example, the agitation scores may be used to present service providers such as electricians, plumbers, and the like. In such cases, the user may be desperate to locate an appropriate worker that is close to them if they are experiencing an emergency situation that requires the service of a particular type of worker.

Embodiments of the invention have a number of technical advantages. First, embodiments can enable real-time responsiveness. According to some embodiments, client-side processing according to embodiments allows for immediate updates and changes in the user interface, providing a more responsive and seamless user experience. Users can see the results of their actions instantly without waiting for server communication. Immediate processing on the client side allows the UI to adapt in real-time based on user actions, enabling highly customized experiences without the need for server intervention. For example, adjusting the feed layout or prioritizing certain content based on detected user agitation can be done instantly.

Second, embodiments can reduce server load. By offloading processing tasks to the client, embodiments relieve the backend server from handling intensive computations, reducing server load and improving overall system scalability. Reducing the need for backend resources and server bandwidth can lower operational costs. Client-side processing distributes the computational load across many devices rather than relying on a centralized server infrastructure. Handling processing on the client side allows the application to scale more easily, as the demand for server resources grows more slowly. Each user's device handles its own computations, making the system inherently more scalable.

Third, embodiments can lower latency. Client-side processing according to embodiments of the invention eliminates the delay caused by round-trip communication with the server. This ensures quicker feedback to the user, which is especially critical in scenarios where real-time interaction is key. Another technical advantage is that methods according to embodiments have offline capability. Client-side processing enables certain functionalities to continue even when the user is offline or has poor network connectivity. This ensures that the application remains functional and responsive regardless of network conditions. With embodiments, sensitive user data can be processed locally on the device, reducing the amount of personal data sent to the server. This enhances user privacy and security, as less information is transmitted over the internet.

Embodiments may also improve the user experience. Users benefit from a more fluid and interactive experience as the application can adapt and respond to their behavior immediately. This is particularly important for applications that need to react dynamically to user inputs, such as in a food delivery application where user agitation can be an issue. Additionally, by processing on the client side, the application can offer a higher level of personalization based on real-time data specific to the user's current context, such as location, battery level, and recent interactions.

Any of the software components or functions described in this application, may be implemented as software code to be executed by a processor using any suitable computer language such as, for example, Java, C++, or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

The above description is illustrative and is not restrictive. Many variations of the invention may become apparent to those skilled in the art upon review of the disclosure. The scope of the invention can, therefore, be determined not with reference to the above description, but instead can be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary.

All patents, patent applications, publications, and descriptions mentioned above are herein incorporated by reference in their entirety for all purposes. None is admitted to be prior art.

What is claimed is:

1. A method comprising:
retrieving, by a user device from a database on the user device, historical data, and real-time client device data;
determining, by the user device, an agitation score based on the real-time client device data and the historical data; and
performing, by the user device, an action based on the agitation score.

2. The method of claim 1, wherein performing the action comprises:
determining, by the user device, a plurality of relevance scores for content based on the agitation score; and
displaying, by the user device, the content based on the relevance scores.

3. The method of claim 1, wherein the determining the agitation score comprises inputting the real-time client device data into a weighted formula, wherein the weighted formula comprises weights that adjust the real-time client device data.

4. The method of claim 3, wherein the weights are dynamically determined by the user device.

5. The method of claim 1, wherein the historical data comprises a time of last order, a last session time, and last application open time.

6. The method of claim 1, wherein the real-time client device data comprises a battery level, a scroll depth, and a location.

7. The method of claim 1, wherein the agitation score is calculated by a server computer in communication with the user device, and wherein the server computer transmits the agitation score to the user device.

8. The method of claim 1, wherein the determining the agitation score comprises inputting the real-time client device data after being normalized into a weighted formula, wherein the weighted formula comprises weights that adjust the real-time client device data.

9. The method of claim 1, wherein performing the action comprises shifting from one resource to another resource.

10. The method of claim 1, wherein the user device comprises an application, which presents images to a user of the user device, a sequence of presented images being altered in response to the agitation score.

11. A user device comprising:
a processor; and
a non-transitory computer readable medium storing a plurality of instructions that, when executed, cause the processors to perform a method comprising:
retrieving, by the user device from a database on the user device, historical data, and real-time client device data;
determining, by the user device, an agitation score based on the real-time client device data and the historical data; and
performing, by the user device, an action based on the agitation score.

12. The user device of claim 11, wherein performing the action comprises:
determining, by the user device, a plurality of relevance scores for content based on the agitation score; and
displaying, by the user device, the content based on the relevance scores.

13. The user device of claim 11, wherein the determining the agitation score comprises inputting the real-time client device data into a weighted formula, wherein the weighted formula comprises weights that adjust the real-time client device data.

14. The user device of claim 13, wherein the weights are dynamically determined by the user device.

15. The user device of claim 13, wherein the historical data comprises a time of last order, a last session time, and last application open time.

16. The user device of claim 11, wherein the agitation score is determined using a machine learning model.

17. The user device of claim 11, wherein the user device comprises an application, which presents images to a user of the user device, a sequence of presented images being altered in response to the agitation score.

18. A system comprising:
a user device comprising
a processor, and
a non-transitory computer readable medium storing a plurality of instructions that, when executed, cause the processors to perform a method comprising,
retrieving, by the user device from a database on the user device, historical data, and real-time client device data,
determining, by the user device, an agitation score based on the real-time client device data and the historical data, and
performing, by the user device, an action based on the agitation score; and
a central server computer storing the historical data in communication with the user device.

19. The system of claim 18, wherein the user device comprises an application which presents images to a user of the user device in response to the agitation score.

20. The system of claim 19, wherein the central server computer is programmed to:
receive, from the user device, a fulfillment request message comprising at least an item associated with an image, wherein the image is presented to the user based on agitation score;
provide the fulfillment request message to a service provider computer operated by a service provider, wherein the service provider initiates preparation of at least the item;
determine one or more transporter user devices;
provide the fulfillment request message to the one or more transporter user devices, wherein the one or more transporter user devices determine whether or not to request to accept the fulfillment request message;
receive an acceptance message from a transporter user device of the one or more transporter user devices;
generate an update message indicating a status of the fulfillment request message; and
provide the update message to the user device.
